(19) United States
(12) Patent Application Publication
(10) Pub. No.: US 2025/0109880 A1
(43) Pub. Date: Apr. 3, 2025

(54) SYSTEMS AND METHODS FOR CONTROLLING A FAN ARRAY

(71) Applicant: XNRGY Climates Systems ULC, Saint-Hubert (CA)

(72) Inventors: Tim Nygaard, Saint-Hubert (CA); William Schwalbach, Saint-Hubert (CA)

(21) Appl. No.: 18/905,942

(22) Filed: Oct. 3, 2024

Related U.S. Application Data
(60) Provisional application No. 63/587,647, filed on Oct. 3, 2023.

(51) Int. Cl. F24F 11/77

(52) U.S. Cl. CPC F24F 11/77

(57) ABSTRACT

Control systems and methods for controlling an array of fans include generating an airflow corresponding to an operational setpoint, selecting a first evaluation fan and a second evaluation fan from among N enabled fans in the array, determining efficiencies of the evaluation fans based on input power, and determining fan speeds of a fan array configuration with N+1 enabled fans and a fan array configuration with N−1 enabled fans. The control systems and methods further include selecting and implementing one of the N−1 configuration, the N+1 configuration, and the original fan array configuration based on efficiencies of the first and second evaluation fans.

### CROSS-REFERENCE TO RELATED APPLICATION(S)

This application claims the benefit under 35 U.S.C. § 119(e) to U.S. Provisional Application 63/587,647, filed Oct. 3, 2023, and entitled “Fan Array Optimization,” which is hereby incorporated herein by reference in its entirety.

### TECHNICAL FIELD

The disclosed technology generally relates to fan arrays and systems and methods for controlling fan arrays.

### BACKGROUND

Air handling units are used in numerous industries and markets. Examples include hyperscale and modular data centers, healthcare facilities, clean rooms, hydroponic agriculture, and life sciences facilities. In a typical application, an air handling unit is a part of a heating, ventilating, and air-conditioning (HVAC) system that is configured to circulate and otherwise handle airflow within the HVAC system. In various cases the primary parts of an air handling unit include a blower, furnace or A/C parts, filters, dampers, and the like. For large industrial and commercial applications, an air handling unit can include multiple blowers, including in the formation of an array of fans.

### BRIEF SUMMARY

The disclosed technology generally relates to control methods and systems for operating or controlling an array of fans, such as a fan array that may form part of an air handling unit. According to one general aspect of the disclosed technology provides a method for controlling an array of fans. The method includes generating an airflow corresponding to an operational setpoint, comprising operating a fan array at a first fan speed. The fan array comprises a first fan array configuration of a plurality of fans. The plurality of fans comprises a number, N, of enabled fans. The method further includes selecting a first evaluation fan and a second evaluation fan from among the N enabled fans and determining an efficiency of the first evaluation fan and an efficiency of the second evaluation fan based on input power supplied to the first and second evaluation fans. The method also includes determining a second fan speed for a second fan array configuration with N+1 enabled fans and determining a third fan speed for a third fan array configuration with N−1 enabled fans. Further, the method includes selecting the first, second, or third fan array configuration based on the efficiencies determined for the first and second evaluation fans and implementing the selected one of the first, second, and third fan array configurations. Implementing one of the confirmations includes enabling and/or disabling one or more of the plurality of fans according to the selected fan array configuration.

Implementations according to this aspect of the disclosure may include one or more of the following features. In some cases selecting the first, second, or third fan array configuration includes selecting the second fan array configuration, and implementing the second fan array configuration includes enabling one of the plurality of fans and operating the enabled fans at the second fan speed. In some implementations selecting the first, second, or third fan array configuration comprises selecting the third fan array configuration, wherein implementing the third fan array configuration comprises disabling one of the plurality of fans, and operating the enabled fans at the third fan speed. In some cases selecting the first, second, or third fan array configuration comprises selecting the first fan array configuration, wherein implementing the first fan array configuration comprises maintaining the currently enabled fans and operating the enabled fans at the first fan speed.

Various implementations may also include wherein determining the efficiency of the first evaluation fan and the efficiency of the second evaluation fan comprises operating the first and second evaluation fans at the second and third fan speeds, respectively, and measuring the input power supplied to the first and second evaluation fans. Further, in some cases determining the efficiency of the first evaluation fan and the efficiency of the second evaluation fan includes using the relationship

$$\frac{Air Flow Rate \times Static Pressure}{Measured Fan Power} .$$

In various cases the method includes operating the Measured Fan Power remaining N enabled fans of the fan array at the first fan speed while operating the first and second evaluation fans at the second and third fan speeds, respectively. In some cases enabling one or more of the fans comprises turning on one or more of the fans, and disabling one or more the fans comprises turning off one or more of the fans. In addition, in some cases enabling one or more of the fans comprises mechanically integrating one or more of the fans, and disabling one or more the fans comprises mechanically isolating one or more of the fans. Mechanically isolating one or more of the fans can comprise operating the one or more fans in a standby state. In some cases operating the one or more fans in the standby state comprises reducing the fan speed to close a damper.

Another general aspect of the disclosed technology includes a control system for controlling the operation of a fan array. The control system includes a system controller configured with instructions stored on a non-transitory memory device. The instructions configure the system controller to carry out a method of controlling the fan array, including generating an airflow corresponding to an operational setpoint, comprising operating a fan array at a first fan speed, the fan array comprising a first fan array configuration of a plurality of fans comprising a number, N, of enabled fans; selecting a first evaluation fan and a second evaluation fan from among the N enabled fans; determining an efficiency of the first evaluation fan and an efficiency of the second evaluation fan based on input power supplied to the first and second evaluation fans; determining a second fan speed for a second fan array configuration with N+1 enabled fans; determining a third fan speed for a third fan array configuration with N−1 enabled fans; selecting the first, second, or third fan array configuration based on the efficiencies determined for the first and second evaluation fans; and implementing the selected one of the first, second, and third fan array configurations, comprising enabling and/or disabling one or more of the plurality of fans according to the selected fan array configuration.

Implementations according to this aspect of the disclosure may include one or more of the following features. In some cases selecting the first, second, or third fan array configuration comprises selecting the second fan array configuration, wherein implementing the second fan array configuration comprises enabling one of the plurality of fans, and operating the enabled fans at the second fan speed. In some cases selecting the first, second, or third fan array configuration comprises selecting the third fan array configuration, wherein implementing the third fan array configuration comprises disabling one of the plurality of fans, and operating the enabled fans at the third fan speed. In some cases determining the efficiency of the first evaluation fan and the efficiency of the second evaluation fan comprises operating the first and second evaluation fans at the second and third fan speeds, respectively, and measuring the input power supplied to the first and second evaluation fans. Some implementations further include operating the remaining N enabled fans of the fan array at the first fan speed while operating the first and second evaluation fans at the second and third fan speeds, respectively.

In some cases enabling one or more of the fans comprises turning on one or more of the fans, and wherein disabling one or more the fans comprises turning off one or more of the fans. In some cases enabling one or more of the fans comprises mechanically integrating one or more of the fans, and wherein disabling one or more the fans comprises mechanically isolating one or more of the fans. In some cases mechanically isolating one or more of the fans comprises operating the one or more fans in a standby state. In some cases operating the one or more fans in the standby state comprises reducing the fan speed to close a damper.

According to an aspect of the disclosed technology, various implementations provide a control system and/or method for controlling an array of fans that includes one or more of the following aspects and/or features. In some cases the system/method has the ability to turn fans off and on and/or adjust speed to generate a required air flow. In some cases the system/method is configured to determine operation based on input power to the fan system, e.g., in watts, in order to account for motor and drive efficiency and actual power consumption by the motor and drive system. In some cases the system/method provides an adaptive, AI-based fan operation configured to adjust the number of fans and/or operating speed based on, e.g., historical facility records and environmental conditions. In some cases the system/method includes interrogating other components in an air handler such as coils and filters to determine an optimum fan configuration. In some cases the system/method includes turning fans on and off if there is a problem with the controller and/or one or more motors and adjusting the remaining operational fans to run at peak efficiency.

In various implementations a method of controlling a fan array includes starting up all fans together, e.g., using a common speed signal, stabilizing and establishing a baseline RPM and a baseline power for each fan in order to achieve an overall desired setpoint. In various cases the setpoint is characterized by a static pressure and/or a volumetric flow. The method also includes designating or establishing at least two evaluation fans and modulating the evaluation fans to determine a speed (RPM) associated with an N+1 fan configuration and an N−1 fan configuration. The method also includes observing efficiency and actual power consumption of the evaluation fans and determining if changing the number of fans is advantageous. If a change in the number of fans would be advantageous, the method includes changing the quantity of enabled fans. In various cases changing the quantity of enabled fans involves turning on or turning off a single fan based on information gained from operation of the evaluation fans. Further, in various implementations the method includes returning to the beginning of the method and repeating the method, e.g., indefinitely.

While multiple implementations and aspects are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic representation of a fan array in a configuration with twelve enabled fans according to various implementations.

FIG. 2 is a graph showing the performance and operating point of the fan array configuration of FIG. 1 according to various implementations.

FIG. 3 is a schematic representation of the fan array of FIG. 1 with adjustments made to two evaluation fans according to various implementations.

FIG. 4 is a schematic representation of the fan array of FIG. 3 in a configuration with one fan disabled according to various implementations.

FIG. 5 is a graph showing the performance and operating point of the fan array configuration of FIG. 4 according to various implementations.

FIG. 6 is a schematic representation of the fan array of FIG. 4 with adjustments made to two evaluation fans according to various implementations.

FIG. 7 is a schematic representation of the fan array of FIG. 6 in a configuration with an additional fan disabled according to various implementations.

FIG. 8 is a schematic representation of a fan array in a configuration with eight enabled fans according to various implementations.

FIG. 9 is a graph showing the performance and operating point of the fan array configuration of FIG. 8 according to various implementations.

FIG. 10 is a schematic representation of the fan array of FIG. 8 with adjustments made to two evaluation fans according to various implementations.

FIG. 11 is a schematic representation of the fan array of FIG. 10 in a configuration with an additional fan enabled according to various implementations.

While multiple implementations and aspects are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### DETAILED DESCRIPTION

Implementations of the disclosed technology provide control systems and methods for controlling and improving or optimizing the operation of an array of fans to meet various air flow requirements. In various implementations, a control system is configured to conduct real-world evaluations of potential operational changes for a fan array. The control system is thus able to determine the actual impact that a potential operational change may provide before implementing the change. The disclosed technology thus provides an advantage over existing fan control systems because the technology can be configured to optimize the operation of an array of fans based on actual conditions as opposed to, e.g., only nominal or theoretical characteristics of the equipment. In various cases this approach also enables the control system to account for historical facility and environmental conditions that inherently affect the operation of the fan array, as well as actual performance characteristics of individual fans in the array.

Implementations of a control system connected to and controlling the operation of multiple fans in an array configuration illustrate the potential benefit of the disclosed technology. In various cases, the control system is configured to change the speed of individual fans and to include or exclude individual fans as needed. In various cases excluding an individual fan may involve turning the fan off, mechanically isolating the fan from other fans, and/or otherwise removing the effect of the fan from the overall fan array. In various cases including an individual fan may involve turning the fan on, mechanically integrating the fan with other fans, and/or otherwise adding the output from the fan to the overall output of the fan array. Various implementations are described herein as using a particular methodology (e.g., turning fans on/off) to include and exclude fans. It is understood that these and other implementations can likewise use alternative methods for excluding and/or including particular fans, including techniques described herein such as, for example, mechanically isolating fans. The terminology of including and excluding fans is used interchangeably herein with similar terminology, including enabling and disabling fans.

In one example, the control system may evaluate a potential change to the operational configuration of the fan array by turning an evaluation fan on or off. After turning the fan on or off, and potentially making changes to other fans to achieve a desired performance, the control system can measure the actual power consumption of the array by, e.g., measuring the input power supplied to the fans. The control system can then compare the measured power consumption to the power required for a previous configuration and determine whether to implement the operational change going forward. In some cases, for example, the control system may determine whether a potential configuration change provides an improved operational efficiency.

As noted above, various implementations of the disclosed technology involve improving the efficiency of a fan array by turning one or more fans on or off. Various examples of such implementations will now be discussed.

### Example 1: Improving Array Efficiency by Shutting Off Fans

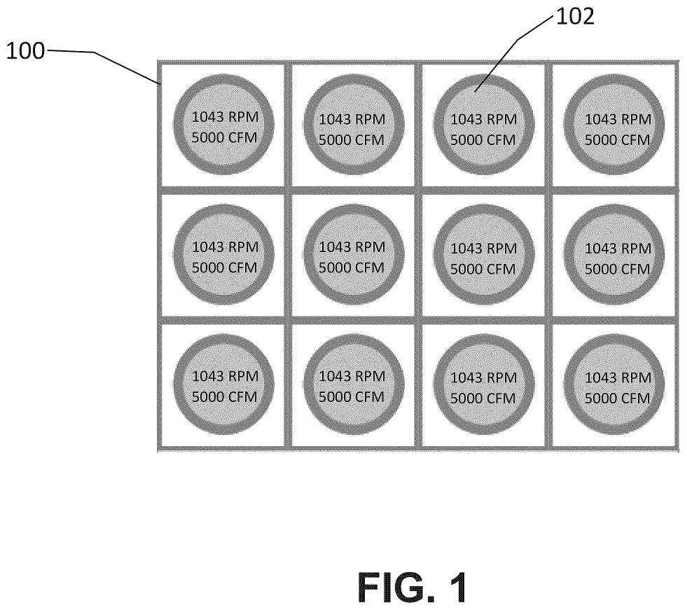

Various implementations involve improving the efficiency of a fan array by dropping or turning off one or more currently enabled fans. FIG. 1 is a schematic representation of an array 100 of twelve fans 102 running in a stable manner. In an initial, stable configuration, the fan array 100 produces an air flow (i.e., volume flow rate) of 60,000 cubic feet per minute (CFM), with each fan 102 generating an air flow of 5,000 CFM. The speed of each of the fans 102 is 1,043 RPM. The fan array 100 produces a static pressure of 3.0 inches water column (inWC) and has an efficiency of 69.9%.

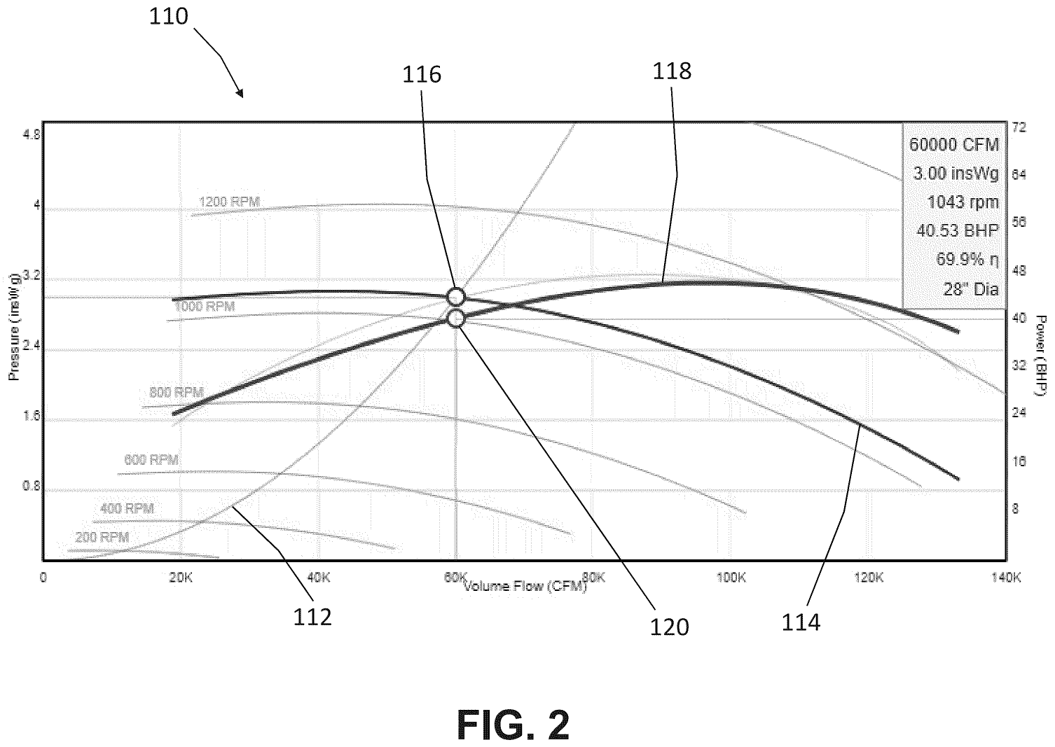

FIG. 2 is a graph 110 of a performance curve for the fan array 100 of FIG. 1. The graph depicts a system curve 112 extending parabolically upward from the origin. A selected pressure-volume curve 114 corresponding to the fan speed of 1,043 RPM extends left to right, starting at about 3 inches water column at 20,000 CFM. The operating point 116 for the fan array 100 occurs at the intersection (60,000 CFM @3.0 inWC) of the illustrated pressure-volume curve 114 and system curve 112. A selected brake horsepower curve 118 extends left to right across the graph, starting at about 24 BHP at 20,000 CFM. The brake horsepower curve 118 depicts a power 120 of about 40.53 BHP at the operating air flow of 60,000 CFM, which corresponds to an efficiency of 69.9%.

The system controller for the fan array 100 is configured to evaluate the potential benefit of various changes to the operational configuration of the fan array 100. In some instances the configuration change includes running an alternative number of fans 102. In this and other various examples, the system controller is configured to evaluate a corresponding pair of potential configurations for the fan array 100 at the same time. One possible pair of array configurations includes an N+1 configuration that adds (e.g., turns on) a new fan 102 and an N−1 configuration that removes (e.g., turns off) an existing fan 102. In such cases, the system controller is configured to calculate the volume air flow rate that each of the fans 102 in the potentially new configurations would need to generate to maintain the current total air flow for the fan array 100.

In the current example, the controller is configured to calculate the required air flow for each fan 102 in an N+1 configuration of thirteen fans (12 currently enabled fans+1 new fan) and the air flow for each fan 102 in an N−1 configuration of eleven fans (12 currently enabled fans−1 currently enabled fan). For the N+1 configuration with thirteen total fans, the system controller determines that each fan 102 needs to generate 4,615 CFM to maintain the current 60,000 CFM. For the N−1 configuration with eleven total fans, the system controller determines that each fan 102 needs to generate 5,455 CFM to maintain the current 60,000 CFM.

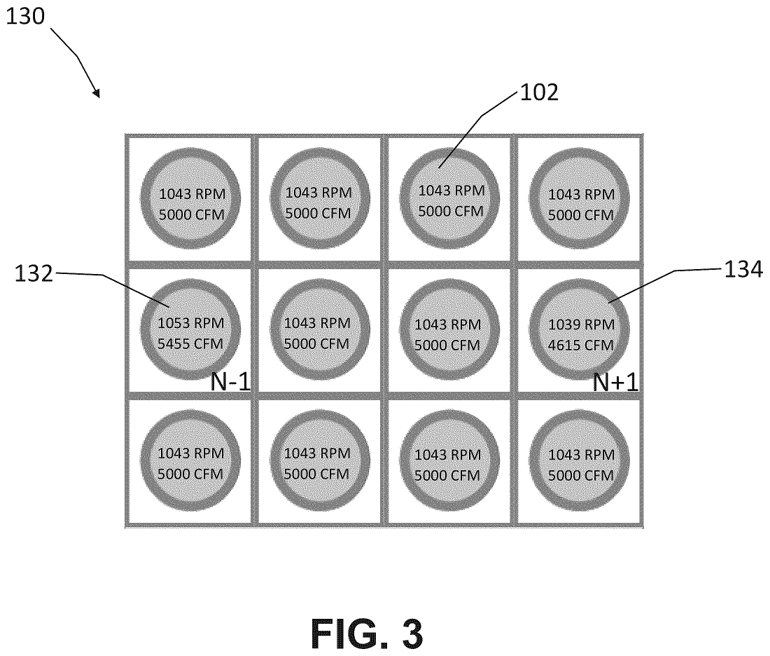

In various cases the system controller evaluates the performance and desirability of potential array configurations by modulating one or more test fans until the desired overall air flow is achieved. FIG. 3 depicts the fan array of FIG. 1 in a first testing or evaluation configuration 130. In the current example, the controller is configured to select two fans 132, 134 of the currently enabled twelve fans 102 to serve as “evaluation fans.” The controller then increases the speed (RPM) of one evaluation fan 132 to produce the increased air flow of 5,455 CFM for the N−1 configuration. The controller also decreases the speed of the second evaluation fan 134 to produce the air flow of 4,615 CFM corresponding to the N+1 configuration. The operation of the remaining array fans 102 remains unchanged in this example. At this point, the overall array in the first configuration 130 is still running at nearly the same parameters as before since the air flow rate change of the first evaluation fan 132 roughly cancels the air flow rate change of the second evaluation fan 134. Fan static pressure remains at 3 inWC.

In various implementations the system controller is configured to next determine the static efficiency of each evaluation fan. In various implementations the controller determines the efficiency using static pressure, air flow rate, and measured input power as follows:

$$Fan Static Efficiency = \frac{Air Flow Rate \times Static Pressure}{Measured Fan Power}$$

In this case the controller determines that the static efficiency of the N+1 fan 134 is 67.6% and that the static efficiency of the N−1 fan 132 is 72.0%. In various cases the controller may determine the static pressure, airflow rate, and measured fan input power based on signals from corresponding sensors and/or known characteristics of the system. In various implementations the efficiencies of the N+1 and N−1 evaluation fans can also be determined using the fan energy index, which corresponds to a ratio of actual fan efficiency to baseline fan efficiency at a given air flow and pressure point.

In various implementations, the total power consumption for the fan array can be calculated for the baseline configuration as well as for the proposed test fan configurations by multiplying the power consumption of a representative fan by the number of fans that are required. The power consumption calculations can then be compared directly. The fan energy index can also be compared at this point.

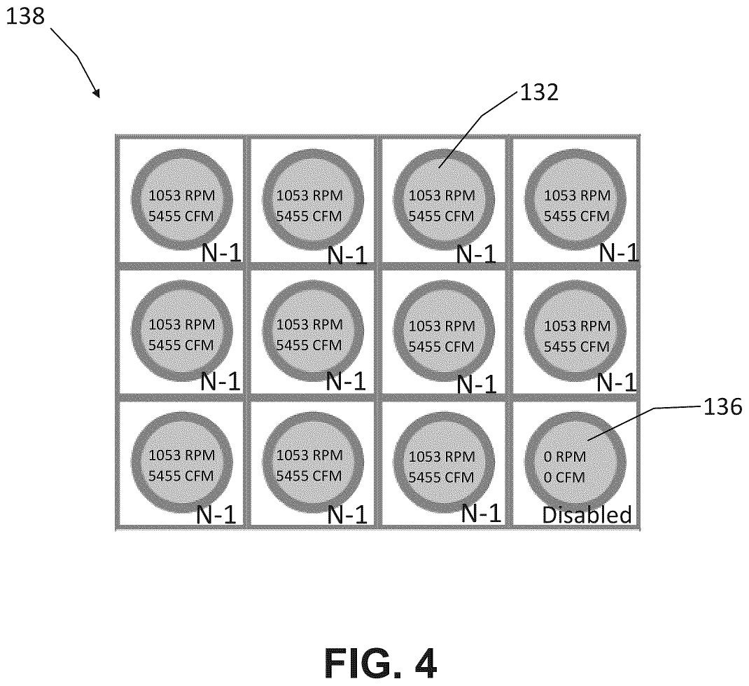

Returning to the example of FIG. 3, since the efficiency dropped in the N+1 fan 134 and increased in the N−1 fan 132, the controller turns off one of the currently enabled fans 136 and adjusts the speed of the remaining fans to match the N−1 fan 132, thus implementing the N−1 configuration 138 as shown in FIG. 4. The controller is configured to then confirm that the N−1 configuration of eleven fans is running in a stable manner while generating 60,000 CFM (5,455 CFM per fan) at 3.0 inWC with 72.0% efficiency.

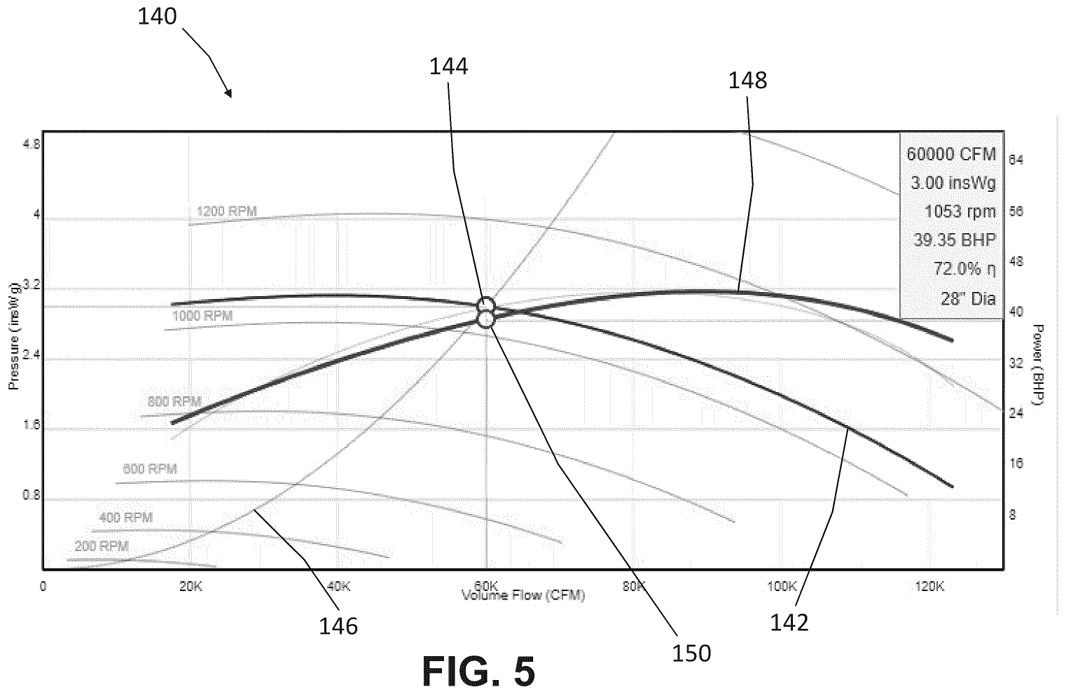

FIG. 5 is a graph 140 that illustrates a performance curve for the fan array N−1 configuration 138 shown in FIG. 4. The graph 140 illustrates the pressure-volume curve 142 corresponding to the fan speed of 1,053 RPM with the operating point 144 for the N−1 configuration 138 occurring at the intersection (60,000 CFM @3.0 inWC) of the illustrated pressure-volume curve 142 and system curve 146. A selected brake horsepower curve 148 extends left to right across the graph, depicting a power 150 of about 39.35 BHP at the operating airflow of 60,000 CFM, which corresponds to an efficiency of 72%. As can be seen from the graph, the adjusted fan array configuration 140 with one fan disabled maintains the original air flow performance of the fan array 100 depicted in FIG. 1 with increased efficiency.

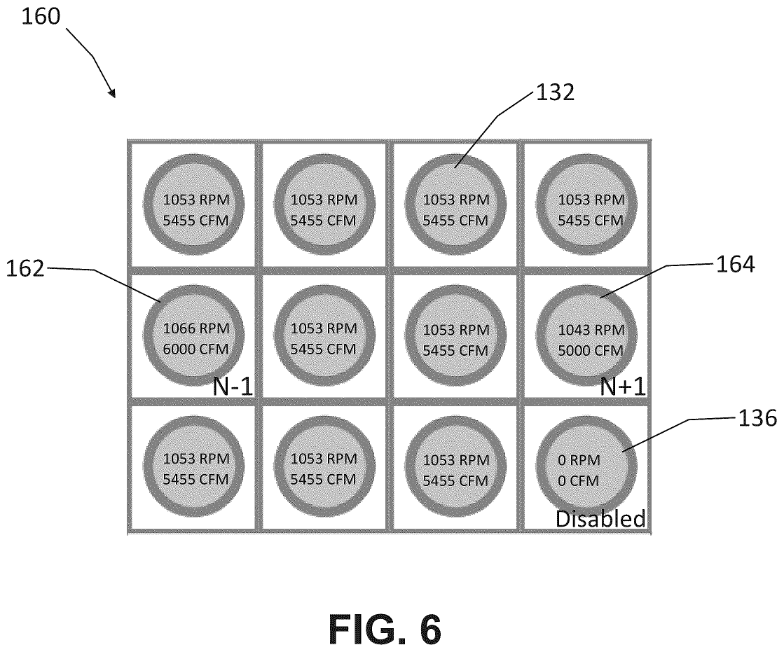

In various implementations, the fan array system controller is configured to continue this method of adding and removing fans multiple times (e.g., indefinitely) in order to further optimize the operation of the fan array. For example, with the fan array currently operating with the N−1 configuration 138 with eleven fans, the system controller may again determine the potential benefit of running an alternate number of fans. Turning to FIG. 6, the system controller has modified the operation of the fan array to implement a second testing configuration 160. In this example, the system controller is configured to calculate the air flow for each fan in a new N+1 configuration of twelve fans (11 currently enabled fans+1 new fan) and the air flow for each fan in a new N−1 configuration of ten fans (11 currently enabled fans−1 currently enabled fan). For the new N+1 configuration with twelve total fans, the system controller determines that each fan 132 needs to generate 5,000 CFM to maintain the current 60,000 CFM. For the new N−1 configuration with ten total fans, the system controller determines that each fan 132 needs to generate 6,000 CFM to maintain the current 60,000 CFM.

The system controller selects first and second evaluation fans 162, 164 and adjusts the speed of the first evaluation fan 162 to produce the airflow for the N−1 configuration and the speed of the second evaluation fan 164 to generate the airflow corresponding to the N+1 configuration as shown in FIG. 6. At this point, the overall array 160 is still running at nearly the same conditions with the air flow rate change of the first evaluation fan 162 roughly canceling out the air flow rate change of the second evaluation fan 164. Fan static pressure remains at 3 inWC.

In various implementations the system controller is configured to next determine the efficiency of each evaluation fan 162, 164 as before. In this case the controller determines that the efficiency of the N+1 fan 164 is 69.9% and that the efficiency of the N−1 fan 162 is 73.9%. In various implementations the efficiencies of the N+1 and N−1 evaluation fans can also be determined by using the fan energy index. In various cases total fan array power consumption can be calculated for the existing configuration as well as the proposed test fan scenarios by multiplying the power consumption of a representative fan by the number of fans that are required. The power consumption calculations can then be compared directly. The fan energy index for each configuration can also be compared at this point.

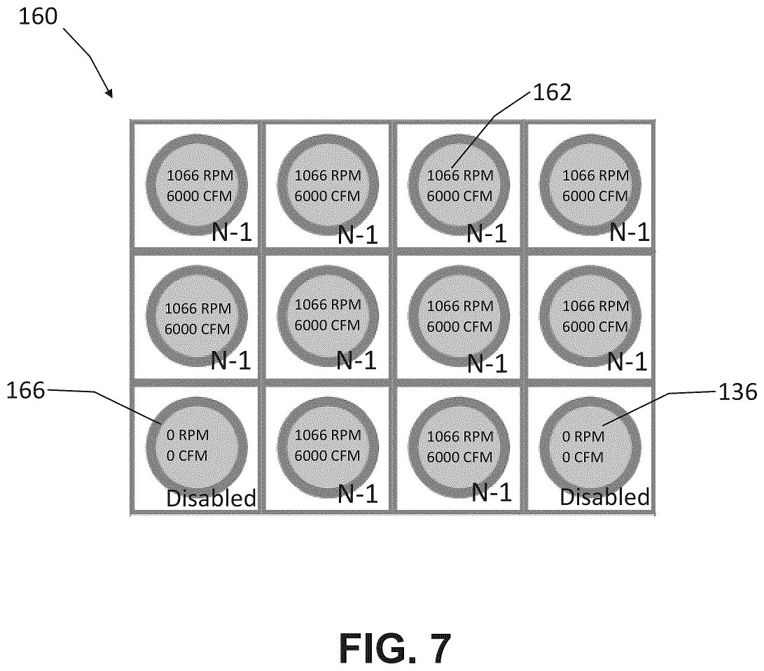

Returning to the example of FIG. 6, since the efficiency dropped in the N+1 fan 164 and increased in the N−1 fan 162, the controller turns off one of the currently enabled fans 166 and adjusts the speed of the remaining fans 162 to implement the new N−1 configuration as shown in FIG. 7. In some cases the controller is configured to continue this process until dropping or adding a fan no longer realizes an appreciable efficiency gain. In various implementations a minimum threshold for an appreciable efficiency gain may be set based on the size of the fan array and/or the effect that switching fans on/off may have on the stability of the system flow. In various implementations the controller is configured to continue this process until dropping or adding a fan no longer realizes any efficiency gain (e.g., zero or negative efficiency gain).

### Example 2: Improving Array Efficiency by Starting Fans

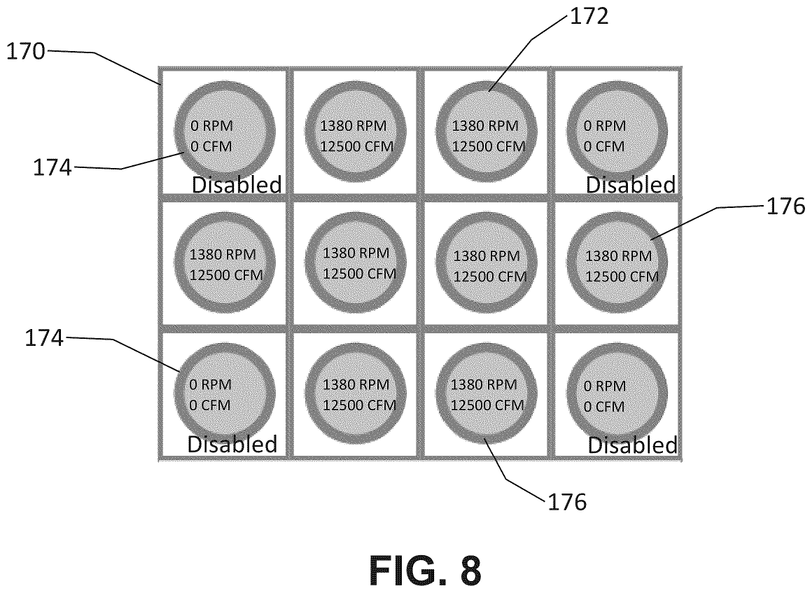

As previously discussed, various implementations of the disclosed technology involve improving the efficiency of a fan array by turning on or off one or more currently disabled fans. FIG. 8 is a schematic representation of an array 170 of twelve fans 172 with four fans 174 disabled or turned off and eight fans 176 running in a stable manner. In an initial, stable configuration, the fan array 170 produces an air flow of 100,000 cubic feet per minute (CFM), with each enabled fan 176 generating an air flow of 12,500 CFM. The speed of each of the operating fans 176 is 1,380 RPM. The fan array 170 produces a static pressure of 3.0 inWC and has an efficiency of 68.1%.

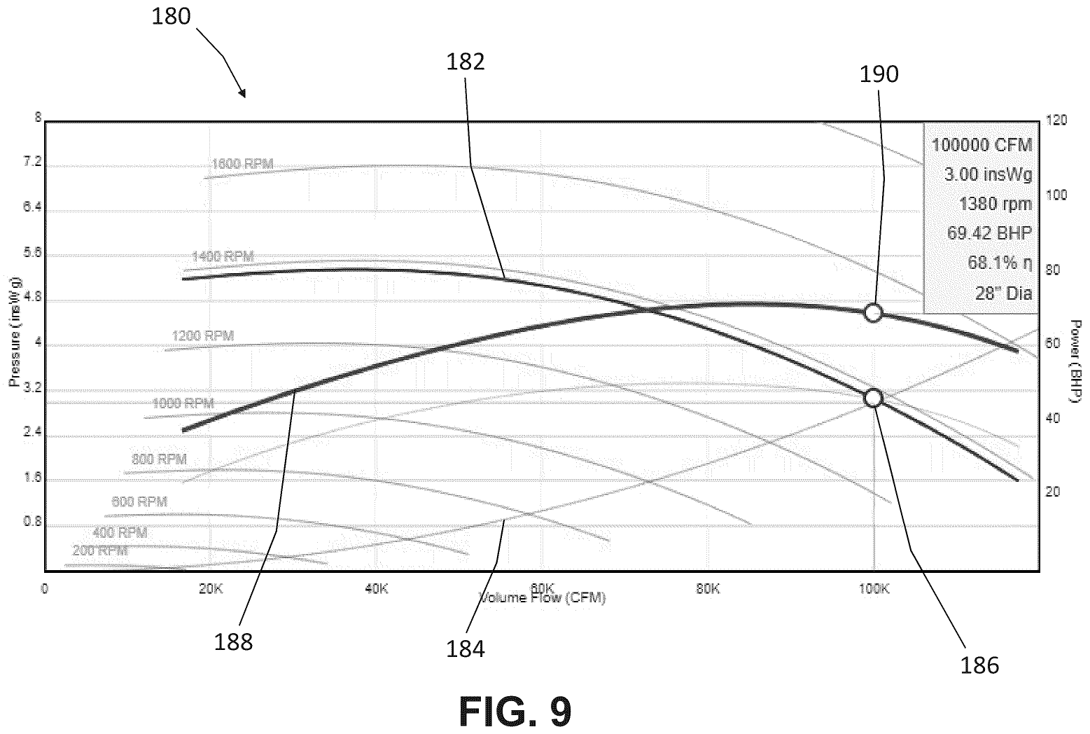

FIG. 9 is a graph 180 showing the corresponding performance curves and operating point of the fan array 170 of FIG. 8. In particular, the graph illustrates a pressure-volume curve 182 intersects the system curve 184 at an operating point 186 of 3 inWC at 100,000 CFM. The graph also depicts a brake horsepower curve 188 indicating a brake horsepower 190 of 69.42 BHP for the operating point of 100,000 CFM.

According to this example, the system controller for the fan array 180 is configured to determine the potential benefit of running an alternative number of fans. In various cases the system controller is configured to evaluate a corresponding pair of potential configurations for the fan array 180 at the same time. One possible pair of array configurations includes an N+1 configuration that adds (e.g., turns on) a new fan and an N−1 configuration that removes (e.g., turns off) an existing fan. In such cases, the system controller is configured to calculate the volume air flow rate that each of the fans in the potentially new configurations would need to generate to maintain the current total air flow for the fan array 180.

In the current example, the system controller is configured to calculate the required air flow for each fan in an N+1 configuration of nine fans (8 currently enabled fans+1 new fan) and the air flow for each fan in an N−1 configuration of seven fans (8 currently enabled fans−1 currently enabled fan). For the N+1 configuration with nine total fans, the system controller determines that each fan needs to generate 11,111 CFM to maintain the current 100,000 CFM. For the N−1 configuration with seven total fans, the system controller determines that each fan needs to generate 14,286 CFM to maintain the current 100,000 CFM.

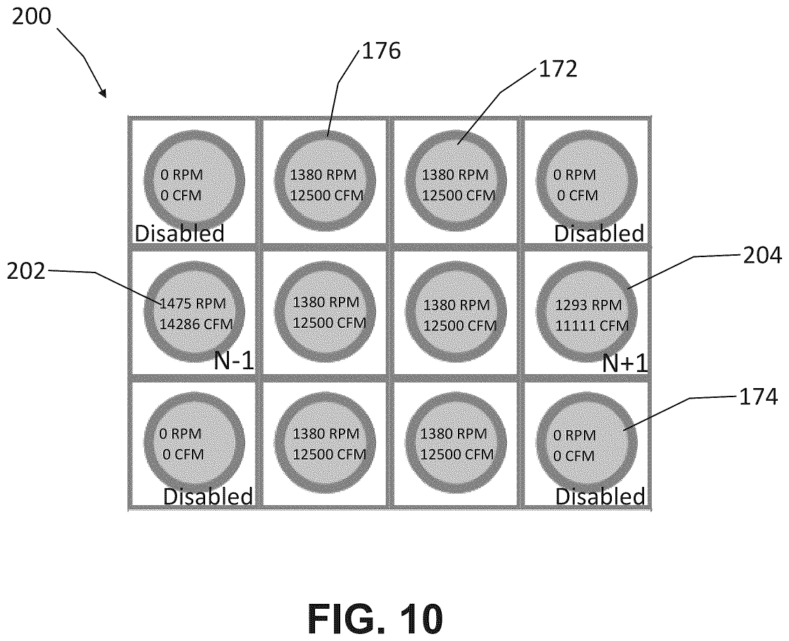

In various cases the system controller evaluates the performance and desirability of potential array configurations by modulating one or more test fans until the desired overall air flow is achieved. FIG. 10 depicts the fan array of FIG. 8 in a testing or evaluation configuration 200. The controller is configured to select two fans 202, 204 of the currently enabled eight fans 176 to serve as evaluation fans. The controller then increases the speed (RPM) of one evaluation fan 202 to produce the increased air flow of 14,286 CFM for the N−1 configuration. The controller also decreases the speed of the second evaluation fan 204 to produce the air flow of 11,111 CFM corresponding to the N+1 configuration. The operation of the remaining array fans 176 remains unchanged in this example. At this point, the overall array in the testing configuration 200 is still running at nearly the same parameters as before since the air flow rate change of the first evaluation fan 202 roughly cancels the air flow rate change of the second evaluation fan 201. Fan static pressure remains at 3 inWC.

In various implementations the system controller is configured to next determine the static efficiency of each evaluation fan 202, 204 as in the previously described examples. In this case the controller determines that the efficiency of the N+1 fan is 71.8% and that the efficiency of the N−1 fan is 66.5%. In various implementations the efficiencies of the N+1 and N−1 fans can also be determined by using the fan energy index. In various cases total fan array power consumption can be calculated for the existing configuration as well as the proposed test fan scenarios by multiplying the power consumption of a representative fan by the number of fans that are required. The power consumption calculations can then be compared directly. The fan energy index can also be compared at this point.

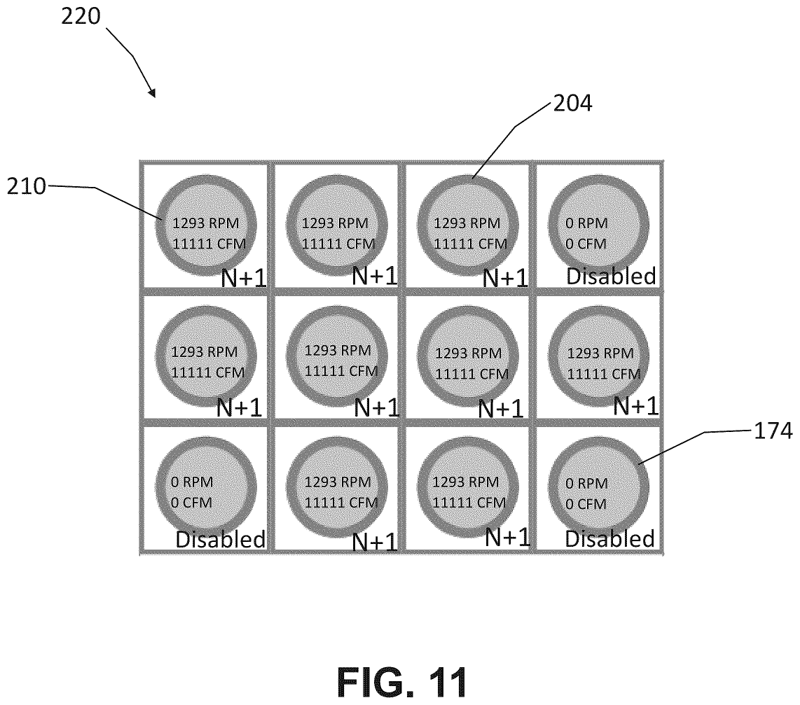

Returning to the example of FIG. 10, since the efficiency dropped in the N−1 fan 202 and increased in the N+1 fan 204, the controller turns on one of the currently disabled fans 210 and adjusts the speed of the remaining enabled fans to implement the N+1 configuration as shown in FIG. 11. In some cases the controller is configured to continue this process until dropping or adding a fan no longer realizes an appreciable efficiency gain. In some cases a minimum threshold for an appreciable efficiency gain may be set based on the size of the fan array and/or the effect that switching fans on/off may have on the stability of the system flow. In various implementations the controller is configured to continue the process until dropping or adding a fan results in zero or negative efficiency gain.

According to various implementations, a control system and/or method for controlling a fan array includes steps for ensuring stable operation on the right side of the fan curve. In some cases the system controller is configured to operate the fan array at approximately 90% of peak pressure.

### Alternative Examples

As discussed elsewhere herein, implementations of the disclosed technology may optimize or otherwise change the operation of an array of fans in various ways. In various cases the control system is configured to change the speed of individual fans. In various cases the control system is configured to include or exclude individual fans as needed. In various cases including or excluding an individual fan involves turning the fan on or off, respectively. As an alternative approach, in various implementations the control system is configured to mechanically isolate a fan from the rest of the fan array instead of turning the fan off. In a similar manner, the control system is sometimes configured to mechanically reintegrate the fan with the other array fans instead of turning on the fan.

In some cases the control system is configured to mechanically isolate individual fans by placing the fan in a standby state. In the standby state, the fan remains running at a very low speed (e.g., RPM). In this state, the fan's backdraft damper (or other damper, motorized damper, etc.) mechanically isolates the fan from the rest of the array so that the fan is not moving any air. Thus, while the fan is still operating, the fan is effectively isolated from the remaining array fans and does not contribute to the overall output of the fan array. To bring the fan out of the standby state, the controller can be configured to increase the fan's speed, at which point the fan's damper opens and the fan is once again operationally integrated with the other fans in the array.

As discussed elsewhere herein, implementations of the disclosed technology incorporate the use of a control system and/or system controller for carrying out various actions. For example, in various implementations the control system is configured to control operation of a fan array including, for example, by turning individual fans on and off and adjusting the speed of individual fans in the array.

According to various implementations, the control system includes a system controller, which may also be referred to as a system processor. The system processor or controller can be implemented by a variety of hardware, software and/or firmware in various cases. In some cases the system processor is configured with instructions for carrying out one or more of the activities, methods, and/or steps outlined herein. The control system and/or system controller may be implemented by a variety of computing devices (e.g., one or more processors, controllers, and/or memory devices with instructions for configuring a processor or controller). An example of hardware utilized to implement the system controller includes one or more microprocessors or other types of processing circuits.

According to various implementations, the system processor or controller includes or is coupled with one or more physical, non-transitory computer accessible or readable storage devices, which are also referred to herein as “memory” and “memory devices.” The memory may be implemented using any suitable memory technology, which may include, e.g., temporary and more long-term configurations, volatile and non-volatile configurations, and solid state and/or other physical formats. Examples of possible memory include random access memory (RAM), dynamic random-access memory (DRAM), static random-access memory (SRAM), magnetic hard discs, optical discs, floppy discs, flash memory, forms of electrically programmable memory (EPROM) and electrically erasable and programmable (EEPROM) memory, and other forms known in the art.

The memory device(s) coupled with the system processor contain instructions for configuring the system processor to perform particular operations or actions by virtue of loading and executing the instructions. The system processor carrying out the instructions causes the control system to carry out the desired actions. References herein to the control system, controller, or other device carrying out various activities imply that the system controller or processor is configured with corresponding instructions for execution.

Although the disclosure has been described with reference to certain implementations and embodiments, persons skilled in the art will recognize that changes may be made in form and detail without departing from the spirit and scope of the disclosed apparatus, systems and methods.

What is claimed is:

1. A method for controlling an array of fans, the method comprising:
generating an airflow corresponding to an operational setpoint, comprising operating a fan array at a first fan speed, the fan array comprising a first fan array configuration of a plurality of fans comprising a number, N, of enabled fans;
selecting a first evaluation fan and a second evaluation fan from among the N enabled fans;
determining an efficiency of the first evaluation fan and an efficiency of the second evaluation fan based on input power supplied to the first and second evaluation fans;
determining a second fan speed for a second fan array configuration with N+1 enabled fans;
determining a third fan speed for a third fan array configuration with N−1 enabled fans;
selecting the first, second, or third fan array configuration based on the efficiencies determined for the first and second evaluation fans; and
implementing the selected one of the first, second, and third fan array configurations, comprising enabling and/or disabling one or more of the plurality of fans according to the selected fan array configuration.

2. The method of claim 1, wherein selecting the first, second, or third fan array configuration comprises selecting the second fan array configuration, wherein implementing the second fan array configuration comprises enabling one of the plurality of fans, and operating the enabled fans at the second fan speed.

3. The method of claim 1, wherein selecting the first, second, or third fan array configuration comprises selecting the third fan array configuration, wherein implementing the third fan array configuration comprises disabling one of the plurality of fans, and operating the enabled fans at the third fan speed.

4. The method of claim 1, wherein selecting the first, second, or third fan array configuration comprises selecting the first fan array configuration, wherein implementing the first fan array configuration comprises maintaining the currently enabled fans and operating the enabled fans at the first fan speed.

5. The method of claim 1, wherein determining the efficiency of the first evaluation fan and the efficiency of the second evaluation fan comprises operating the first and second evaluation fans at the second and third fan speeds, respectively, and measuring the input power supplied to the first and second evaluation fans.

6. The method of claim 5, further comprising determining the efficiency of the first evaluation fan and the efficiency of the second evaluation fan with the relationship
$$\frac{Air Flow Rate \times Static Pressure}{Measured Fan Power} .$$

7. The method of claim 5, further comprising operating the remaining N enabled fans of the fan array at the first fan speed while operating the first and second evaluation fans at the second and third fan speeds, respectively.

8. The method of claim 1, wherein enabling one or more of the fans comprises turning on one or more of the fans, and wherein disabling one or more the fans comprises turning off one or more of the fans.

9. The method of claim 1, wherein enabling one or more of the fans comprises mechanically integrating one or more of the fans, and wherein disabling one or more the fans comprises mechanically isolating one or more of the fans.

10. The method of claim 9, wherein mechanically isolating one or more of the fans comprises operating the one or more fans in a standby state.

11. The method of claim 10, wherein operating the one or more fans in the standby state comprises reducing the fan speed to close a damper.

12. A control system for controlling the operation of a fan array, the control system comprising a system controller configured with instructions stored on a non-transitory memory device, the instructions configuring the system controller to carry out a method of controlling the fan array, the method comprising:
generating an airflow corresponding to an operational setpoint, comprising operating a fan array at a first fan speed, the fan array comprising a first fan array configuration of a plurality of fans comprising a number, N, of enabled fans;
selecting a first evaluation fan and a second evaluation fan from among the N enabled fans;
determining an efficiency of the first evaluation fan and an efficiency of the second evaluation fan based on input power supplied to the first and second evaluation fans;
determining a second fan speed for a second fan array configuration with N+1 enabled fans;
determining a third fan speed for a third fan array configuration with N−1 enabled fans;
selecting the first, second, or third fan array configuration based on the efficiencies determined for the first and second evaluation fans; and
implementing the selected one of the first, second, and third fan array configurations, comprising enabling and/or disabling one or more of the plurality of fans according to the selected fan array configuration.

13. The system of claim 12, wherein selecting the first, second, or third fan array configuration comprises selecting the second fan array configuration, wherein implementing the second fan array configuration comprises enabling one of the plurality of fans, and operating the enabled fans at the second fan speed.

14. The system of claim 12, wherein selecting the first, second, or third fan array configuration comprises selecting the third fan array configuration, wherein implementing the third fan array configuration comprises disabling one of the plurality of fans, and operating the enabled fans at the third fan speed.

15. The system of claim 12, wherein determining the efficiency of the first evaluation fan and the efficiency of the second evaluation fan comprises operating the first and second evaluation fans at the second and third fan speeds, respectively, and measuring the input power supplied to the first and second evaluation fans.

16. The system of claim 15, further comprising operating the remaining N enabled fans of the fan array at the first fan speed while operating the first and second evaluation fans at the second and third fan speeds, respectively.

17. The system of claim 12, wherein enabling one or more of the fans comprises turning on one or more of the fans, and wherein disabling one or more the fans comprises turning off one or more of the fans.

18. The system of claim 12, wherein enabling one or more of the fans comprises mechanically integrating one or more of the fans, and wherein disabling one or more the fans comprises mechanically isolating one or more of the fans.

19. The system of claim 18, wherein mechanically isolating one or more of the fans comprises operating the one or more fans in a standby state.

20. The system of claim 19, wherein operating the one or more fans in the standby state comprises reducing the fan speed to close a damper.
